(19) United States
(12) Patent Application Publication
(10) Pub. No.: US 2013/0155305 A1
(43) Pub. Date: Jun. 20, 2013

(54) ORIENTATION OF ILLUSTRATION IN ELECTRONIC DISPLAY DEVICE ACCORDING TO IMAGE OF ACTUAL OBJECT BEING ILLUSTRATED

(71) Applicant: PETER SHINTANI, San Diego, CA (US)

(72) Inventor: PETER SHINTANI, San Diego, CA (US)

(73) Assignee: SONY CORPORATION

(21) Appl. No.: 13/330,428

(22) Filed: Dec. 19, 2011

(51) Int. Cl. H04N 5/225; G06K 9/68

(52) U.S. Cl. 348/333.01; 382/218; 348/E05.024

(57) ABSTRACT

A user of an e-book is presented with a changed visual appearance of a presentation on a display that includes a reference image of an object according to a virtually real time image of the object taken by a camera.

### I. FIELD OF THE INVENTION

The present application relates generally to orienting an illustration in an electronic display device such as an e-book according to a real time image of an object that is the subject of the illustration.

### II. BACKGROUND OF THE INVENTION

Electronic books including electronic technical manuals and electronic maps usefully display stored photographs of objects such as parts to be worked on or geographic landmarks that a person can reference when viewing the actual part or landmark to gain information. As an example, an automotive technical manual in e-book form might contain a photograph of a starter mounted on an engine, and a technician can view the photograph while standing in front of an actual engine to gain instructions for mounting or removing the starter.

As understood herein, however, because the e-book images typically are taken from a particular aspect and the concomitant written instructions typically refer to the object as it appears in the particular aspect, users sometimes happen to view the actual object from a different perspective or aspect. Indeed, it may not be readily apparent that the user is viewing the actual object that is the subject of e-book image. This can cause difficulty understanding the link between what the user is seeing and what the user is reading from the e-book.

### SUMMARY OF THE INVENTION

Accordingly, a system has a housing, a display supported by the housing, and a camera supported by the housing. A processor controls the display and receives input from the camera. Computer readable code means are accessible to the processor and store a reference image of an object that can be presented on the display under control of the processor. The camera generates an object image of the object, and the processor accesses the object image and alters a presentation on the display of the reference image according to the object image.

In some implementations the processor alters the presentation on the display of the reference image according to the object image by combining the object image with the reference image. In other implementations or in addition, the processor can alter the presentation on the display of the reference image according to the object image by combining the object image with the reference image using alpha blending to blend the object image into the reference image. Still further, in some embodiments the processor may alter the presentation on the display of the reference image according to the object image by presenting an instruction on the display to turn the display. Yet again, the processor can alter the presentation on the display of the reference image according to the object image by presenting an arrow on the display indicating a direction in which to turn the display.

If desired, the processor can compare the object image to a library of reference images using image recognition to determine how to alter the presentation on the display of the reference image according to the object image. The processor can also or alternatively alter the presentation on the display of the reference image according to the object image by reorienting the reference image on the display to match an orientation indicated in the object image.

In example embodiments a light emitter such as a laser source is on the housing. The processor causes the light emitter to illuminate a portion of the object. The object can be a part to be worked on by a user of the system, a geographic landmark, or other object depicted by the reference image.

In another aspect, a method includes receiving an object image of an object and comparing the object image to a reference image of the object. The method also includes, responsive to comparing the object image to the reference image, changing, on a display, a visual presentation of the reference image.

In another aspect, an electronic book has a display and a processor controlling the display to present a presentation on the display including a reference image of an object. A camera communicates a virtually real time image of the object to the processor to cause the processor to change a visual appearance of the presentation on the display including the reference image of the object according to the virtually real time image of the object taken by the camera.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of a non-limiting example system in accordance with present principles;

FIG. 2 is a flow chart of example logic;

FIG. 3 is a schematic diagram of an e-book with object being imaged; and

FIGS. 4-6 are example screen shots of the e-book illustrating coordination of orientation principles.

### DETAILED DESCRIPTION OF THE PREFERRED EMBODIMENT

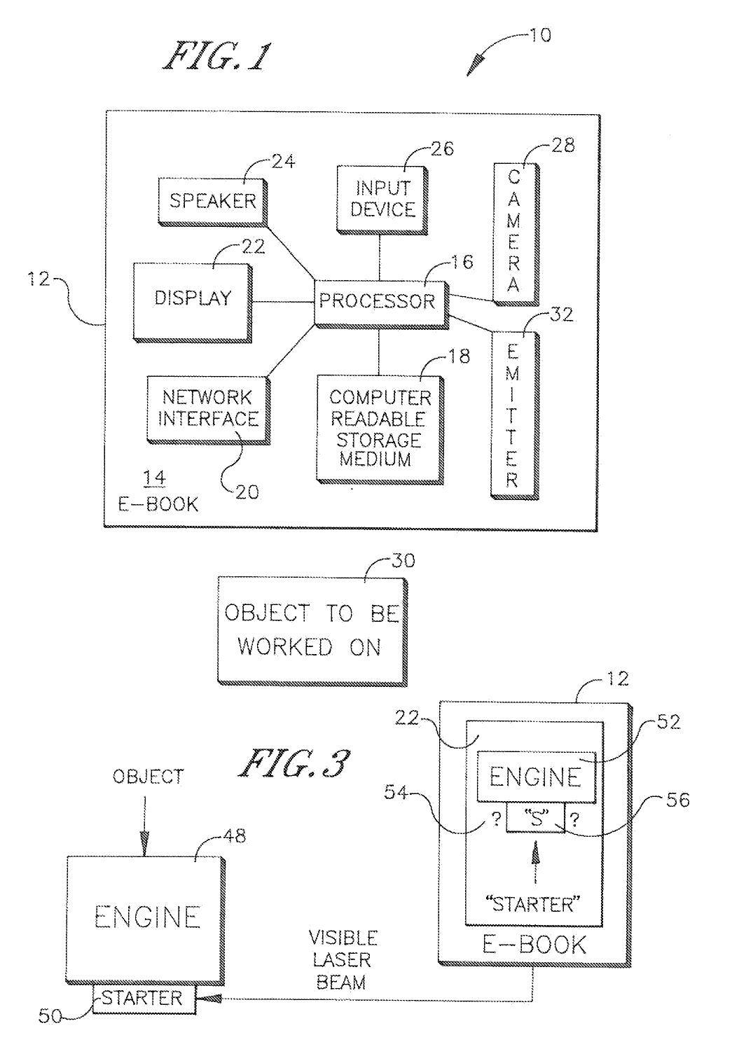

Referring initially to the non-limiting example embodiment shown in FIG. 1, a system 10 includes an electronic book (e-book) 12 that has a typically although not necessarily portable lightweight housing 14. A processor 16 is within the housing 14, and the processor 16 accesses one or more tangible computer readable storage media 18 such as disk-based or solid state storage.

The e-book 12 can receive streaming video, firmware updates, text files, etc. through the Internet using a wired or wireless network interface 20 (such as a modem or router) communicating with the processor 16. Text and if desired video can be presented under control of the processor 16 on a display 22, which may be a touch screen display. Audio may be played on one or more speakers 24 under control of the processor 16. Also, user commands to the processor 16 may be received from an input device 26 such as a mouse, keypad, keyboard, the touchscreen, a microphone inputting signals to a voice recognition module, etc. An imaging device 28 such as a CCD-based camera or other camera can input images of an object 30 to the processor 16, and in example embodiments the processor 16 can control a visible light emitter 32 such as a laser in accordance with description below. The emitter 32 is movably mounted on the housing 14.

According to principles divulged below, image recognition and orientation is incorporated into the e-book 12 to allow for automatic correlation of e-book references images to actual captured images. Briefly, the e-book 12 receives feedback from the camera 28 to enable the e-book to indicate to the user to orientate the e-book 12 in an orientation that makes visual correlation of a reference image of the object presented by the e-book to the actual object in front of the user easier. The e-book can also highlight on the electronic image the component that is to be looked into more detail in that portion of the manual.

FIG. 2 illustrates example logic on accordance with present principles. Block 34 indicates that an actual image of the object 30 is captured by the camera 28 and sent to the processor 16. The actual image a virtually real-time, i.e., is captured by a user of the e-book causing the camera to take a picture of the object 30 while the user is visually sighting the object, so that the picture is of the object in real time or virtually so, perhaps no more than a few seconds old before it undergoes the processing described below. For instance, the camera can produce a static image which is updated in a nearly real time manner, e.g., update rate is approximately 15 frames/sec or faster, or the camera can be a video camera, with a fixed but short (<one second) delay.

Moving to block 36, the processor 16 may execute image recognition on the image from the camera to identify the object at block 38, which may be, without limitation, a machine part to be worked on, a geographic landmark, etc. The processor does this by accessing a database of images contained on the computer readable medium 18 or contained in an Internet server and accessed using the network interface 20. Alternatively, the image may be uploaded from the e-book to an Internet server and the server can execute image recognition on it, returning an identification of the object to the e-book through the network interface 20. In any case, the object 30 using its virtually real time image is correlated to a reference image of the same object typically contained on the computer readable storage medium 18.

Proceeding to block 40, in one example embodiment the reference image of the object that is stored on the computer readable storage medium 18 may be presented on the display 22 and re-oriented (rotated) on the display 22 to match the orientation of the object in the virtually real time image received from the camera 28. Alternatively, the presentation of the reference image may be altered by, e.g., presenting on the display 22 a visible indication such as an arrow or text instruction (block 42) for the user to manually move either the object 30 or more likely the e-book, e.g., to turn the e-book to an orientation in which the depicted reference image of the object will appear to be oriented like the actual object 30 as indicated by the virtually real time image of the object captured at block 34. Note that this latter approach permits the reference image along with any pre-stored instructions that may typically relate to the particular orientation of the reference image to remain unchanged on the display 22, except for the addition of the above-described textual or graphic overlay onto the image to instruct the user how to rotate or otherwise reorient the e-book so that the reference image orientation matches the object image orientation as captured at block 34.

Block 44 indicates that if desired, responsive to the object image captured at block 34, the processor may control the illumination and direction of the laser from the emitter 32 onto the object 30 to provide visible indication to a user viewing the object 30 of a particular portion of interest on the object, as discussed further below.

Also, at block 46 the object image captured at block 34 may be combined with the reference image of the same object stored on the computer readable storage medium 18 by, e.g., alpha bending the images together to render a composite image on the display 22. The constituents of the composite image may be re-sized and/or reoriented as appropriate to match each other. In this way, the composite image on the display 22 retains both the informational aspects of the reference image while rendering an image that more closely resembles the object image captured at block 34. The understanding behind the logic at block 46 is that sometimes a reference image may have been taken under different lighting conditions than the conditions in which the user is currently viewing the object, or may have been taken using a different color of object than the currently viewed object 30, or otherwise might not clearly resemble the actual object as closely as the composite image affords.

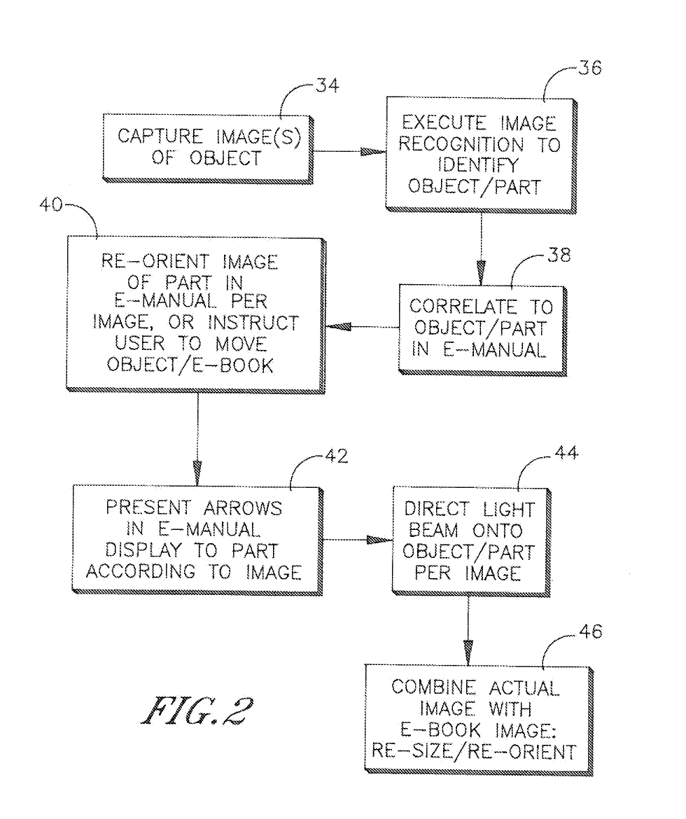

FIG. 3 illustrates. The example object depicted in FIG. 3 is a vehicle engine 48 on which is mounted a starter 50. In this case, the e-book 12 contains an electronic repair manual for the starter. As shown, the user has called up a page on the display 22 on which is presented a reference image 52 of the engine with starter. Based on the actual image of the engine 48 taken by the camera 28 and using logic above, the e-book has recognized the starter 50 and responsive thereto has highlighted (as shown by the penumbra 54) the portion 56 of the reference image that is the starter. Also, as shown in FIG. 3 the e-book has presented a text message declaring that the highlighted portion of the reference image is the starter. These are two examples of how the presentation of the reference image 52 is altered according to the actual image of the object taken by the camera.

FIGS. 4-6 illustrate further principles for how the presentation of the reference image 52 can be altered according to the actual image of the object taken by the camera. Assume FIG. 4 illustrates an initial orientation of the reference image 52 as the user views the actual engine 48 prior to imaging the engine 48 with the camera 28. As shown, the orientation of the reference image 52 with respect to the display 22 is perpendicular to the actual orientation of the engine 48 as viewed by the user, i.e., the user views the engine 48 with its long dimension horizontal, while the reference image 52 in FIG. 4 shows the engine oriented with its long dimension vertical relative to the display 22.

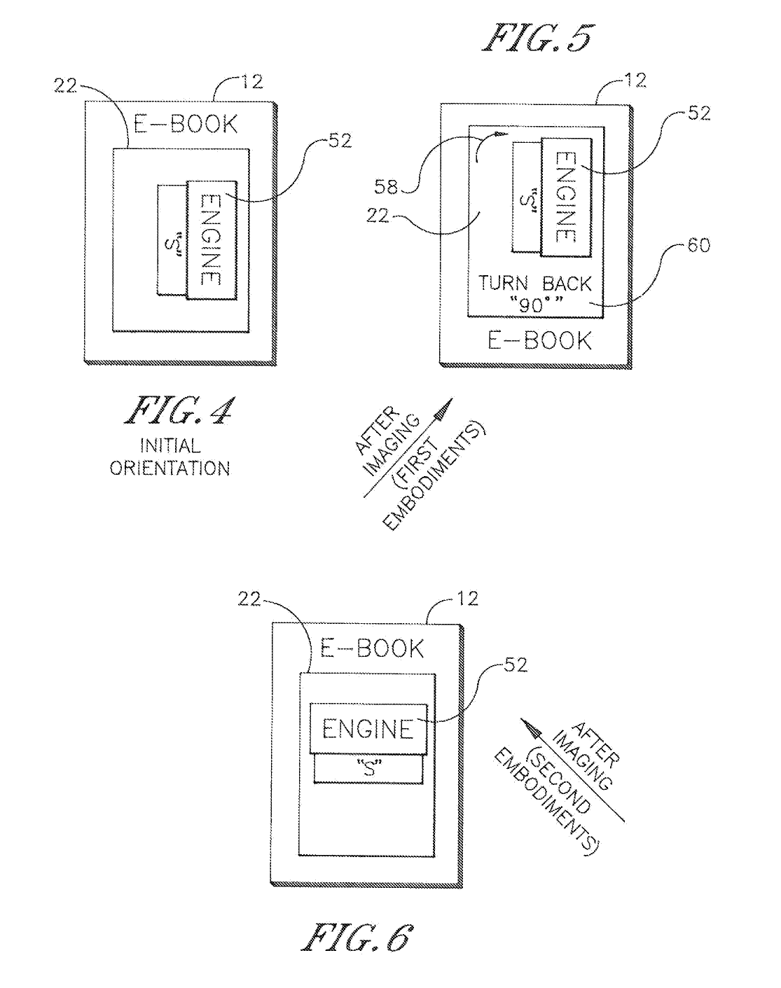

After imaging, FIGS. 5 and 6 illustrate different embodiments of changing the presentation of the reference image 52. In FIG. 5, after imaging the orientation of the reference image 52 remains unchanged from FIG. 4, which has the advantage of not having to reconfigure the entire page, including text, presented on the display 22. However, as also shown the user is given both a graphical indication in the form of a curved arrow 58 and a textual indication in the form of a text instruction 60 to manually rotate or turn the e-book 12 ninety degrees so that the orientation of the reference image 52 with respect to the display 22 matches the orientation of the engine 48 with respect to the ground, with the edge of the display 22 nearest the user typically being interpreted by the user as representing the ground beneath the engine 48.

In contrast, FIG. 6 shows that responsive to the image of the engine 48 from the camera 28, the orientation of the reference image 52 relative to the display 22 can be rotated as appropriate to match that of the engine 48, in this example, by ninety degrees. Thus, the user need not turn or rotate the e-book to reorient the reference image; the processor 16 simply reorients the reference image on the display to match the orientation of the engine as imaged by the camera.

Note that a series of images of the object 30 may be taken by the camera 28, e.g., as the user conducts repairs on the object, and this series of images can be logged in storage for quality assurance review. Also, in the event that an image from the camera indicates an anomaly when compared to the reference image, a warning can be presented on the e-book 12. As an example, suppose the processor 16 executing image recognition recognizes the image from the camera as being part of a reference image except for two fasteners lacking in the image from the camera. A text warning such as “two screws are missing” can be presented on the display 22 in response to this determination.

An alternative to directing the user to turn the e-book to a particular orientation may be a message to direct the user to look at and image a particular item on the object imaged by the camera. For example, a message “look at the oil filter cap” can be generated to cause the user to look at and image the particular portion of the engine designated in the message, resulting in orienting the user to an aspect and angle relative to the object being viewed that more closely matches the aspect at which the reference image was taken. Yet again, no image recognition may be executed on the image from the camera. Instead, the user may be instructed to orient the e-book as indicated by a red dot on the display derived from the image from the camera 28, or to orient himself in front of a red dot on the object 30 from the emitter 32 that is steered onto the object 30 responsive to the perceived orientation of the object from the camera 28 image.

While the particular ORIENTATION OF ILLUSTRATION IN ELECTRONIC DISPLAY DEVICE ACCORDING TO IMAGE OF ACTUAL OBJECT BEING ILLUSTRATED is herein shown and described in detail, it is to be understood that the subject matter which is encompassed by the present invention is limited only by the claims.

1. A system comprising:
housing;
display supported by the housing;
camera supported by the housing;
processor configured for controlling the display and receiving input from the camera; and
computer readable storage medium accessible to the processor and storing at least one reference image of an object presentable on the display under control of the processor, the camera configured for generating an object image of the object, the processor configured for accessing the object image and altering a presentation on the display of the reference image according to the object image, wherein the processor is configured to compare the object image to reference images in a library of reference images using image recognition to determine how to alter the presentation on the display of the reference image according to the object image.

2. The system of claim 1, wherein the processor alters the presentation on the display of the reference image according to the object image by combining the object image with the reference image.

3. The system of claim 1, wherein the processor alters the presentation on the display of the reference image according to the object image by combining the object image with the reference image using alpha blending to blend the object image into the reference image.

4. The system of claim 1, wherein the processor alters the presentation on the display of the reference image according to the object image by presenting an instruction on the display to turn the display.

5. The system of claim 1, wherein the processor alters the presentation on the display of the reference image according to the object image by presenting an arrow on the display indicating a direction in which to turn the display.

6. (canceled)

7. The system of claim 1, wherein the processor alters the presentation on the display of the reference image according to the object image by reorienting the reference image on the display to match an orientation indicated in the object image.

8. The system of claim 1, comprising a light emitter on the housing, the processor causing the light emitter to illuminate a portion of the object.

9. The system of claim 1, wherein the object is a part of a device that is not the system to be mechanically worked on by a user of the system.

10. The system of claim 1, wherein the object is a geographic landmark.

11. A method comprising:
receiving an object image of an object;
comparing the object image to a reference image of the object in a library of reference images using image recognition to determine how to alter the presentation on a display of the reference image according to the object image to render a modified reference image; and
presenting, on the display, a visual presentation of the modified reference image.

12. The method of claim 11, wherein the modified reference image is established at least in part by combining the object image with the reference image.

13. The method of claim 11, wherein the modified reference image is established at least in part by combining the object image with the reference image using alpha blending to blend the object image into the reference image.

14. The method of claim 11, wherein the modified reference image is established at least in part by presenting an instruction on the display to turn the display.

15. The method of claim 11, wherein the modified reference image is established at least in part by presenting an arrow on the display indicating a direction in which to turn the display.

16. (canceled)

17. The method of claim 11, wherein the modified reference image is established at least in part by reorienting the reference image on the display to match an orientation indicated in the object image.

18. The method of claim 11, comprising causing a light emitter to illuminate a portion of the object according to a comparison of the object image with the reference image.

19. An apparatus, comprising:
a display;
a processor configured for controlling the display to present a presentation on the display including a reference image of an object; and
a camera configured for communicating a virtually real time image of the object to the processor to cause the processor to change a visual appearance of the presentation on the display including the reference image of the object according to the virtually real time image of the object taken by the camera, wherein the processor compares the image of the object to at least one reference image in a library of reference images using image recognition to determine how to change, on the display, the visual presentation of the reference image from a visual presentation of the reference image as established in the library.

20. The apparatus of claim 19, wherein the processor changes a visual appearance of the presentation on the display including the reference image of the object according to the virtually real time image of the object taken by the camera by one or more of:
combining the object image with the reference image;
combining the object image with the reference image using alpha blending to blend the object image into the reference image;
presenting an instruction on the display to turn the display;
presenting an arrow on the display indicating a direction in which to turn the display; and
reorienting the reference image on the display to match an orientation indicated in the object image.
